(19) United States
(12) Patent Application Publication
(10) Pub. No.: US 2016/0216216 A1
(43) Pub. Date: Jul. 28, 2016

(54) MAGNETIC DISK INSPECTION DEVICE AND MAGNETIC DISK INSPECTION METHOD

(71) Applicant: HITACHI HIGH-TECH FINE SYSTEMS CORPORATION, Saitama (JP)

(72) Inventors: Shigeru SERIKAWA, Kamisato (JP); Takayuki ISHIGURO, Kamisato (JP)

(21) Appl. No.: 14/917,701

(22) PCT Filed: Sep. 11, 2014
(86) PCT No.: PCT/JP2014/074127

§ 371 Date: Mar. 9, 2016

(30) Foreign Application Priority Data
Sep. 30, 2013 (JP) 2013-203519

(51) Int. Cl. G01N 21/95; G01N 21/88

(52) U.S. Cl. CPC G01N 21/95; G01N 21/8851; G01N 21/8806; G01N 2201/103; G01N 2201/06113

(57) ABSTRACT

To increase horizontal resolution while preventing the depth of focus, a magnetic disk inspection device is configured: a table part which has a spindle shaft and a stage; a lighting system which irradiates a magnetic disk; a specularly reflected light detection optical system; a scattered light detection optical system; and a signal processing unit which processes outputs from the specularly reflected light detection optical system and the scattered light detection optical system and detects a defect, in which the scattered light detection optical system is provided with a lens system and a photoelectric converter having a plurality of photoelectric conversion elements arranged in an array, and using the lens system, forms an image of the scattered light on the photoelectric converter, which is long in one direction and thinner than the width of the photoelectric conversion element in a direction perpendicular to the direction of the arrangement in an array.

### TECHNICAL FIELD

The present invention relates to a magnetic disk inspection device and a magnetic disk inspection method for optically inspecting a defect in a surface of a magnetic disk.

### BACKGROUND ART

An example of a magnetic disk inspection device that optically inspects a defect in a surface of a magnetic disk is described in Patent Literature 1.

Patent Literature 1 discloses, as the magnetic disk inspection device, an optical inspection device for detecting defect position information used in determination of a sampling position in a read-write test, by optical inspection. It is described that the optical inspection device includes an illumination optical system, a scattered-light detection optical system, a specularly-reflected-light detection optical system, and a signal processing and control system, detects specularly reflected light of reflected light from a magnetic disk by the specularly-reflected-light detection optical system and detects scattered light by the scattered-light detection optical system, and processes each of detection signals to detect a defect in a surface of the magnetic disk.

### CITATION LIST

### Patent Literature

Patent Literature 1: Japanese Patent Application Laid-Open No. 2011-159330

### SUMMARY OF INVENTION

### Technical Solution

For recognize the size of the defect more accurately, a method is known that improves a horizontal resolution in the scattered-light detection optical system of the magnetic disk inspection device.

The improvement of the horizontal resolution (making the horizontal resolution finer) is achieved by reducing the size of a beam to reduce the pitch of one scan. The reduction in the size of the beam radiated onto an inspection object surface of the magnetic disk enables the inspection object surface to be read with a finer pitch, resulting in improvement of the horizontal resolution.

However, when the pitch of reading is reduced, the number of scans performed increases, thus increasing a time required for inspection. Also in this case, the reduction in the beam diameter makes a focal depth shallow. As a result of this, when disk runout, extraction or contraction of a mechanism portion, or the like occurs, the scanned light cannot be read with a sensor, so that the productivity of detection is lowered.

Meanwhile, a method is known that increases a magnifying power of detection in the scattered-light detection optical system. As the magnifying power of the scattered-light detection optical system increases, the focal depth seen from the scattered-light detection optical system becomes shallower. Therefore, the same phenomenon as that described above occurs.

In order to improve the horizontal resolution in the magnetic disk inspection device described in Patent Literature 1, it is necessary to make the pitch of the scan finer or increase the magnifying power of the detection system, resulting in the shallow focal depth.

The present invention provides a magnetic disk inspection device and a magnetic disk inspection method that can improve the horizontal resolution without making the focal depth shallow.

### Solution to Problem

In order to solve the above-described problem, according to the present invention, a magnetic disk inspection device is configured to include: a table unit that includes a spindle shaft rotatable with a magnetic disk as an inspection object placed thereon, and a stage capable of moving the spindle shaft in a radial direction of the placed magnetic disk; an illumination system that radiates laser onto a surface of the magnetic disk placed on the spindle shaft; a specularly-reflected-light detection optical system that detects specularly reflected light among reflected light from the surface of the magnetic disk onto which the laser is radiated by the illumination system; a scattered-light detection optical system that detects scattered light of the reflected light from the surface of the magnetic disk onto which the laser is radiated by the illumination system; and a signal processing unit that processes an output of the specularly-reflected-light detection optical system detecting the specularly reflected light and an output of the scattered-light detection optical system detecting the scattered light, to detect a defect on the magnetic disk. The scattered-light detection optical system includes a lens system having a plurality of lenses and a photoelectric converter having a plurality of photoelectric conversion elements arranged in an array, and images with the lens system an image of scattered light from the surface of the magnetic disk onto the photoelectric conversion elements of the photoelectric converter arranged in the array, the image being shaped to be narrower than a width of the photoelectric conversion elements in a direction perpendicular to a direction in which the photoelectric conversion elements are arranged in the array and to extend in one direction.

Also, in order to solve the above-described problem, according to the present invention, a magnetic disk inspection method includes: while a spindle shaft is rotated with a magnetic disk as an inspection object placed thereon, moving the spindle shaft in a radial direction of the placed magnetic disk; radiating laser onto a surface of the magnetic disk placed on the rotating spindle shaft; detecting specularly reflected light among reflected light from the surface of the magnetic disk onto which the laser is radiated with a specularly-reflected-light detection optical system; detecting scattered light of the reflected light from the surface of the magnetic disk onto which the laser is radiated with a specularly-reflected-light detection optical system; and processing an output from the specularly-reflected-light detection optical system detecting the specularly reflected light and an output from the scattered-light detection optical system detecting the scattered light, to detect a defect on the magnetic disk. In this method, detecting the scattered light with the scattered-light detection optical system is achieved by using a lens system including a plurality of lenses and a photoelectric converter including a plurality of photoelectric conversion elements arranged in an array and by imaging an image of the scattered light from the surface of the magnetic disk with the lens system onto the photoelectric conversion elements of the photoelectric converter arranged in the array, the image of the scattered light being shaped to be narrower than a width of the photoelectric conversion elements in a direction perpendicular to a direction in which the photoelectric conversion elements are arranged in the array and to extend in one direction.

### Advantageous Effects of Invention

According to the present invention, the horizontal resolution can be improved without making the focal length shallow in the magnetic disk inspection device and the magnetic disk inspection method. Therefore, it is possible to detect a finer defect.

### BRIEF DESCRIPTION OF DRAWINGS

FIG. 1 is a block diagram illustrating a schematic configuration of a magnetic disk inspection device according to an embodiment of the present invention.

FIG. 2A is a block diagram of a side view of a scattered-light detection optical system according to the embodiment of the present invention.

FIG. 2B is a block diagram of a plan view of the scattered-light detection optical system according to the embodiment of the present invention.

FIG. 3A is a plan view of a sensor of the scattered-light detection optical system according to the embodiment of the present invention.

FIG. 3B is a graph showing a waveform of light received by one pixel of the sensor of the scattered-light detection optical system according to the embodiment of the present invention.

FIG. 3C is an enlarged plan view of a portion of the sensor of the scattered-light detection optical system according to the embodiment of the present invention, showing a state where a scattered-light image of a defect crosses a dead zone of the sensor.

FIG. 4 is a plan view of a sensor used in a scattered-light detection optical system in a comparative example of the present invention.

### DESCRIPTION OF EMBODIMENTS

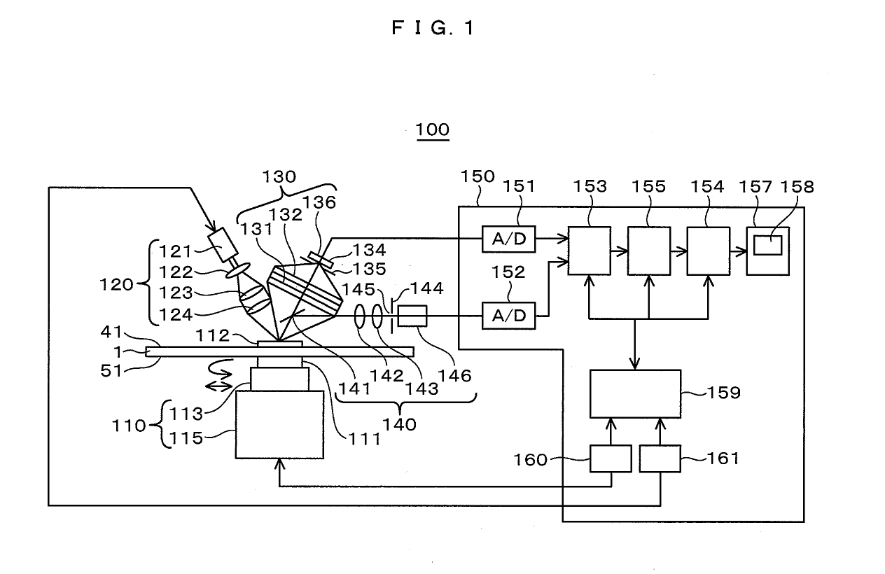

FIG. 1 is a diagram illustrating a detailed configuration of a magnetic disk inspection device 100. The magnetic disk inspection device 100 is configured to roughly include a table unit 110, an illumination optical system 120, a scattered-light detection optical system 130, a specularly-reflected-light detection optical system 140, and a signal processing and control system 150.

The table unit 110 is configured to include a spindle shaft 111 that can rotate with a sample 1 (a magnetic disk) placed thereon, a chuck 112 that chucks the sample 1 placed on the spindle shaft 111, a spindle motor 113 that rotates and drives the spindle shaft 111, and a movable stage 115 on which the spindle shaft 111 and the spindle motor 113 are mounted and which can move in a direction perpendicular to a rotation axis of the spindle shaft 111.

The illumination optical system 120 includes a laser source 121, an enlarging lens 122 enlarging a beam diameter of laser emitted from the laser source 121, a collective lens 123 collecting the laser having the enlarged beam diameter, and a converging lens 124 converging the collected laser onto a surface 41 of the sample 1.

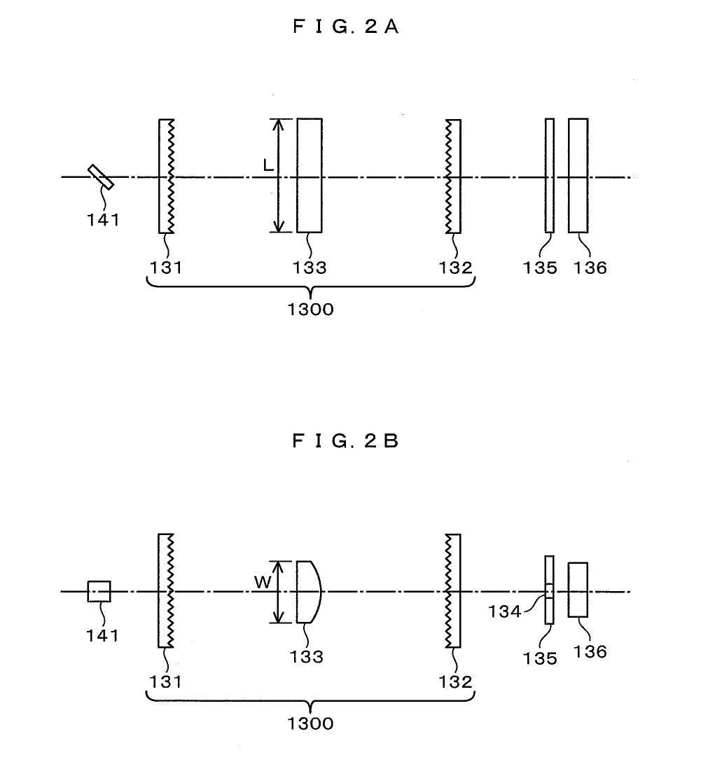

The scattered-light detection optical system 130 includes: a first aspherical Fresnel lens 131, corresponding to an objective lens, that collects scattered light of reflected light (specularly reflected light and the scattered light) from the surface 41 of the sample 1; a second aspherical Fresnel lens 132, corresponding to an imaging lens, that images the light obtained by converging the collected scattered light with a cylindrical lens 133 illustrated in FIGS. 2A and 2B in one direction; a slit plate 135 having a slit 134 that allows the scattered light having a thin linear shape after being transmitted through the second aspherical Fresnel lens 132 to pass therethrough, and blocking stray light other than the scattered light; and a first photoelectric converter 136 (e.g., an avalanche photodiode (APD) or a photomultiplier tube (PMT)) that has a plurality of light-receiving elements (a sensor array) detecting an optical image of the scattered light passing through the slit 134 of the slit plate 135, formed by the second aspherical Fresnel lens 132.

The specularly-reflected-light detection optical system 140 includes a mirror 141 that reflects the specularly reflected light of the reflected light (the specularly reflected light and the scattered light) from the sample 1 to switch an optical path, a collective lens 142 collecting the specularly reflected light of which the optical path is switched, and an imaging lens 143 making the specularly reflected light collected by the collective lens 142 pass through a slit 145 of a slit plate 144 to image the specularly reflected light onto a second photoelectric converter 146 (an APD) with stray light other than the specularly reflected light blocked. The mirror 141 is formed to have a sufficiently small shape not to reflect light other than the specularly reflected light (the scattered light). The second photoelectric converter 146 includes a plurality of detection elements (light-receiving elements: for example, a photodiode array or an avalanche photodiode (APD) array having a plurality of pixels).

The signal processing and control system 150 includes: a first A/D conversion unit 151 that performs A/D conversion for a detection signal from the scattered-light detection optical system 130; a second A/D conversion unit 152 that performs A/D conversion for a detection signal from the specularly-reflected-light detection optical system 140; a signal processing unit 153 that receives an output of the first A/D conversion unit 151 and an output of the second A/D conversion unit 152 to perform signal processing for them; an integrated signal processing unit 155 that integrates the output of the first A/D conversion unit 151 and the output of the second A/D conversion unit 152, that have been processed by the signal processing unit 153, and processes the integrated outputs; a memory 154 storing the result of the processing by the integrated signal processing unit 155; an input and output unit 157 that outputs the result of the processing by the integrated signal processing unit 155 and has a display screen 158 allowing input of an inspection condition; a magnetic-disk-inspection-device control unit 159 that controls the entire magnetic disk inspection device 100; a table control unit 160 that receives a control signal of the magnetic-disk-inspection-device control unit 159 to control the table unit 110 at an optical inspection position; and an inspection-optical-system control unit 161 that receives a control signal of the magnetic-disk-inspection-device control unit 159 to control the illumination optical system 120.

Next, an operation of each component in the above-described configuration is described in a case of inspecting a magnetic disk.

While the sample 1 held on the spindle shaft 111 by the chuck 112 is driven and rotated by the spindle motor 113, the spindle shaft 111 is moved by the movable stage 115 at a constant rate in a direction perpendicular to the spindle shaft 111 (a radial direction of the rotating sample 1). Simultaneously with this operation, the laser source 121 of the illumination optical system 120 controlled by the inspection-optical-system control unit 161 is operated to emit laser.

The surface 41 of the sample 1 irradiated with the laser generates reflected light (scattered light and specularly reflected light) in accordance with the surface condition, such as a defect or a damage in the surface, minute unevenness (roughness) of the surface. The scattered light is distributed in accordance with the size of the defect in the surface of the sample 1. That is, scattered light from a large defect or damage is distributed with a relatively high intensity and a directivity, whereas scattered light from a minute defect or damage is isotropically distributed with a relatively low intensity.

The specularly reflected light of the reflected light from the surface 41 of the sample 1 irradiated with the laser is reflected by the mirror 141 of the specularly-reflected-light detection optical system 140 arranged on the side of an outgoing angle that is equal to an angle of incidence of the laser incident on the surface 41 of the sample 1 (that is, arranged on an optical path of the specularly reflected light), thereby traveling toward the collective lens 142. The specularly reflected light from the sample 1, incident on the collective lens 142, is transmitted through the collective lens 142 to be collected, and is made by the imaging lens 143 to pass through the slit 145 of the slit plate 144 arranged on the collected position to form an image of the surface 41 of the sample 1 on a light-receiving surface of the second photoelectric converter 146. The mirror 141 is formed to have a sufficiently small shape so that it does not reflect light other than the specularly reflected light (the scattered light) towards the collective lens 142.

Meanwhile, a portion of light (the scattered light) that is a portion of the reflected light (the scattered light and the specularly reflected light), generated by the defect, the damage, the minute roughness of the surface, or the like, from the surface 41 of the sample 1 irradiated with the laser and is not reflected by the mirror 141 is incident on the first aspheric Fresnel lens 131 working as an objective lens of the scattered-light detection optical system 130. This incident light is collected and is then incident on the second aspherical Fresnel lens 132 working as a converging lens to be imaged on a detection surface (not shown) of the first photoelectric converter 136, thereby being detected by the first photoelectric converter 136 with a high sensitivity.

The first aspheric Fresnel lens 131 and the second aspheric Fresnel lens 132 are thinner and lighter than a conventional optical lens. Therefore, it is possible to manufacture a lens barrel (not shown) for accommodating them with a relatively compact size, as compared with a lens barrel for the conventional optical lens, increasing the freedom in a position of installment above the sample. This enables numerical aperture (NA) to be designed to be 0.6 or more (NA in a case of using the conventional optical lens is 0.4 or less). Consequently, a large detection signal can be obtained as compared with detection using a detection optical system configured by a conventional optical lens system employing no aspheric Fresnel lens, because the scattered light from the minute defect is approximately isotropically distributed above a substrate and therefore the level of the detection signal is in proportion to the area of the detection surface when the detection sensitivity is the same. Accordingly, it is possible to detect the scattered light from a smaller defect, as compared with a conventional technique.

The A/D conversion units 152 and 152 convert analog signals output from the first photoelectric converter 136 and the second photoelectric converter 146 to digital signals, and amplify and output the digital signals, respectively.

The digital signals output from the A/D conversion units 151 and 152 are input to the signal processing unit 153. The signal processing unit 153 processes each of the output signal from the first photoelectric converter 136 and the output signal from the second photoelectric converter 146, both converted to be digital, to detect the defect present in the surface 41 of the sample 1. Information on the detected defect is subjected to specification of a position of the detected defect on the sample 1, which uses information on a laser radiation position on the sample 1 obtained from the table control unit 160 controlling the table unit 110. The defect information for which the position on the sample 1 is specified is sent to the integrated signal processing unit 155 to be subjected to integrated processing, so that the type of the detected defect is specified based on features of the detection signals from the first photoelectric converter 136 and the second photoelectric converter 146. The result is displayed on the display screen 158 of the input and output unit 157.

The configuration using the aspherical Fresnel lens 131 and the aspherical Fresnel lens 132 for the scattered-light detection optical system 130 is described in the present embodiment. In place of these lenses, a combination of aspherical lenses and/or usual spherical lenses may be used.

Next, the scattered-light detection optical system 130 according to the present embodiment is described. FIG. 2A is a front view of the scattered-light detection optical system 130 in the present embodiment, and FIG. 2B is a plan view thereof. The scattered-light detection optical system 130 is configured to include: a lens system 1300 receiving light (scattered light), which is a portion of reflected light (the scattered light and specularly reflected light) generated by a defect, a damage, a minute surface unevenness, or the like when laser radiated to the sample 1 (the magnetic disk) hits the sample 1, but is not reflected by the mirror 141; and the photoelectric converter 136 receiving the scattered light that has been incident on the lens system 1300 to be optically adjusted, through the slit plate 135, and converting the scattered light into an electric signal.

The lens system 1300 of the scattered-light detection optical system 130 is configured to include: the first aspherical Fresnel lens 131, corresponding to an objective lens, collecting the scattered light of the reflected light (the specularly reflected light and the scattered light) from the surface 41 of the sample 1, which remains after the specularly reflected light is reflected by the mirror 141; a cylindrical lens 133 (that is not shown in the diagram of the entire configuration in FIG. 1) that converges the scattered light from the sample 1, collected by the first aspherical Fresnel lens 131 to be collimated light, in one direction and emits the scattered light as collimated light in a direction perpendicular to the one direction; and the second aspherical Fresnel lens 132, corresponding to an imaging lens, that images the scattered light from the sample 1 converged by the cylindrical lens 133 in the one direction. In the present embodiment, the cylindrical lens 133 emits the scattered light from the rotating sample 1 as collimated light in a direction perpendicular to the rotation of the sample 1 (a radial direction of the sample 1) and emits that scattered light in a direction of the rotation (the tangential direction of the sample 1) to be converged.

The scattered light transmitted through the second aspherical Fresnel lens 132 of the lens system 1300 passes through the slit 134 formed in the slit plate 135, so that an optical image formed by the second aspherical Fresnel lens 132 is detected by the first photoelectric converter 136 (a sensor e.g., an avalanche photodiode (APD) or a photomultiplier tube (PMT)). Stray light other than the scattered light is not detected by the first photoelectric converter 136 because of being blocked by the slit plate 135.

The cylindrical lens 133 collects only a portion of the scattered light from the surface 41 of the sample 1 collected by the first aspherical Fresnel lens 131. Because of this point, the amount of light exiting from the second aspherical Fresnel lens 132 is reduced as compared with a case where the cylindrical lens 133 is not employed in the lens system 1300. However, it is possible to set a magnifying power to be different between a longer-diameter side L and a shorter-diameter side W of the cylindrical lens 133.

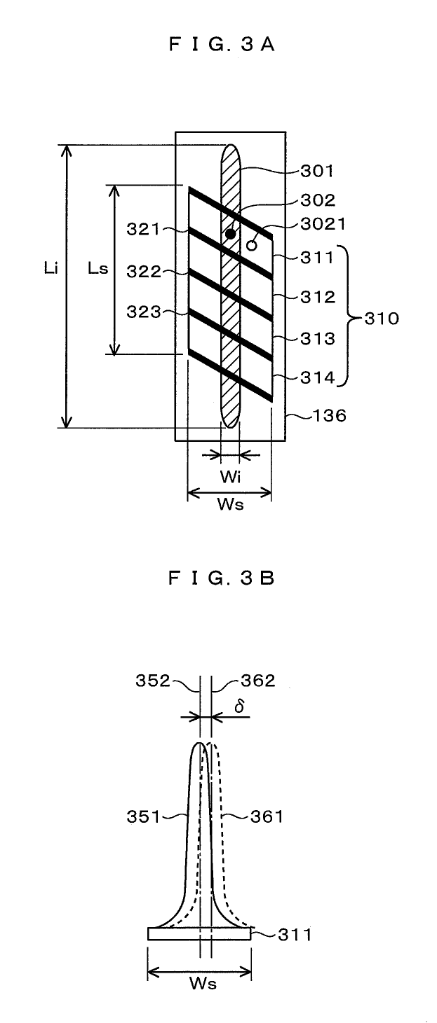

The sensor 136 receives the light, which is transmitted through the cylindrical lens 133, exits from the second aspherical Fresnel lens 132, and passes through the slit plate 135, on its light-receiving surface 310 (see FIG. 3A) and converts the received light into an electric signal in accordance with the amount of the received light.

The light exiting from the lens system 1300 has an elliptical shape in a cross section perpendicular to its optical axis. That is, an image (e.g., 302) of the scattered light from the sample 1 is projected in a projection region 301 on the light-receiving surface of the sensor 136, by the magnification about 100 to about 150 times in a light longer axis Li and about 15 to about 20 times in a light minor axis direction Wi. The projection region 301 of the sample 1 on the light-receiving surface 310 of the sensor 136 has a length Li longer than the length Ls of the light-receiving surface 310 of the sensor 136 in a longitudinal direction (a direction in which light-receiving elements (photoelectric conversion elements) 311 to 314 are arranged in the light-receiving surface 310) of the sensor 136, but has a width Wi narrower than the width Ws of the sensor 136 in a lateral direction (a width direction of the light-receiving elements 311 to 314 of the light-receiving surface 310).

The horizontal resolution of the sensor 136 is determined by the individual light-receiving elements 311 to 314 forming the sensor 136. Therefore, even if the position of the projection region 301 having the width Wi is changed within a range of the light-receiving elements 311 to 314 having the width Ws, the horizontal resolution is not lowered, so long as the light-receiving elements 311 to 314 having the width Ws can receive the scattered light in the projection region 301 having the width Wi narrower than the width Ws. In other words, even if face deflection of a disk, expansion or contraction of a mechanism portion, or the like occurs to cause a positional change of the image 302 of the scattered light generated from the defect on the sample 1 that is received by the sensor 136, the change does not affect the horizontal resolution so long as the range of the change falls within the range of the light-receiving elements 311 to 314 having the width Ws.

In the present embodiment, the magnifying power on the light minor axis Wi of the projection region 301 of the sample 1 projected onto the light-receiving surface 310 of the sensor 136 is lower than that on the light longer axis Li. Therefore, the sensitivity of the positional shift in the direction of the light minor axis Wi is low, as compared with the positional shift in the direction of the light longer axis Li. Consequently, as compared with a case where the cylindrical lens 133 is not used in the lens system 1300, it is possible to suppress occurrence of a phenomenon that the projection region 301 of the sample 1 is out of the light-receiving surface 310 in the direction of the light minor axis Wi and therefore the sensor 136 cannot receive the image of the scattered light generated by the defect in the projection region 310 of the sample 1.

This is shown in FIG. 3B. In FIG. 3B, a waveform 351 is a waveform of intensity distribution of the scattered light on the element 311 when the image of the scattered light is located at the position of the image 302 of the scattered light in FIG. 3A, and a waveform 361 is a waveform of intensity distribution of the scattered light when the image of the scattered light is shifted to a position 3021 in FIG. 3A. The center 362 of the waveform 361 is shifted from the center 352 of the waveform 351 by δ on the element 311. However, in the case of FIG. 3B, the center position 362 of the waveform 361 is within the range of the width Ws of the element 311 even if the center position 362 is shifted with respect to the waveform 351 by δ. Therefore, the level of the output signal of the element 311 is not changed.

Because the magnifying power in the width direction (the direction of the light minor axis of the projection region 301) of the sensor 136 is lower than that in the length direction (the direction of the light longer axis of the projection region 301), the sensitivity to the positional change of the image of the scattered light from the defect in the projection region 301 in the width direction of the sensor 136 is lower than that in the length direction of the sensor 136. Therefore, even if face deflection of a disk, extraction or contraction of a mechanism portion, or the like occurs and causes the change of the projection region 301 of the sample 1 on the light-receiving surface 310, resulting in a change in the imaging position of the scattered light image 302 of the defect, this change does not affect the horizontal resolution and the defect can be detected, so long as the range of the change is within the range of the width Ws of the light-receiving surface 310.

Dead zones 321 to 323 of insulting material are formed between the elements 311 to 314 configuring the light-receiving surface 310 of the sensor 136 in order to electrically insulate and separate adjacent one of the elements from each other.

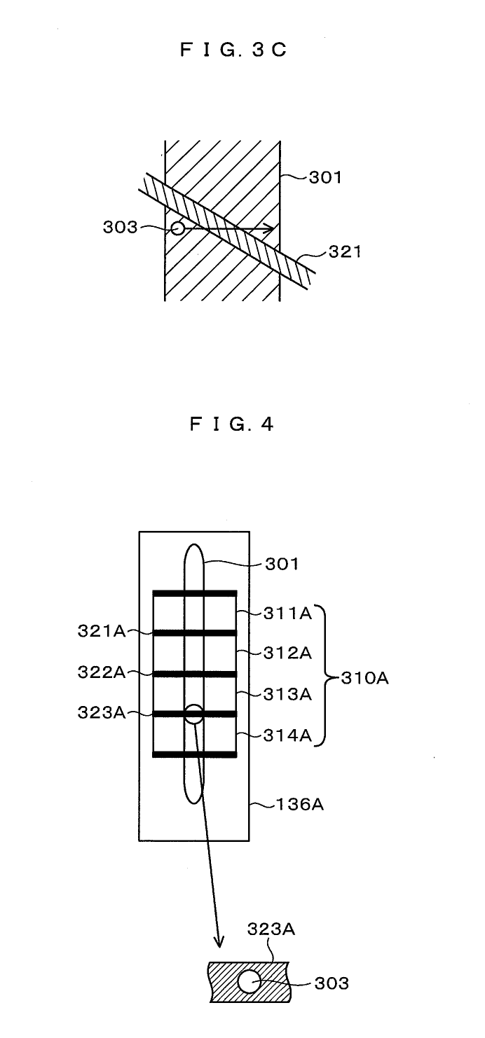

As illustrated in FIG. 4 as a comparative example of the present embodiment, a case is considered in which each of light-receiving elements 311A to 314A configuring a light-receiving surface 310A of a sensor 316A is formed to be square or rectangular and dead zones 321A to 323A are formed between the light-receiving elements 311A to 314A, and a defect on the sample 1 is small and an image 303 of scattered light generated by the defect, that is projected onto the light-receiving surface 310A, has the same size as or a smaller size than the width of the dead zones 321A to 323A. In this case, because an image of the surface 41 of the sample 1 is moving along the longitudinal direction of the dead zones 321A to 323A, none of the light-receiving elements 311A to 314A detects the image of the scattered light when the image of the scattered light caused by the defect approximately completely overlaps any of the dead zones 321A to 323A on the light-receiving surface 310A.

In order to prevent occurrence of the above-described case, each of the light-receiving elements 311 to 314 configuring the light-receiving surface 310 of the sensor 136 in the present embodiment is formed to be a parallelogram, as illustrated in FIG. 3A, and the dead zones 321 to 323 of the insulating material are formed diagonally, as illustrated in FIG. 3A. By this diagonal formation of the dead zones 321 to 323, even if the image 303 of the scattered light caused by the defect has such a size that the image 303 approximately completely overlaps any of the dead zones 321 to 323 (the dead zone 321 in the case of FIG. 3C) on the light-receiving surface 310, the image 303 of the scattered light crosses any of the dead zones 321 to 323 (the dead zone 321 in the case of FIG. 3C) when traveling from left to right as shown with an arrow. Consequently, the image of the scattered light is detected by any of the light-receiving elements 311 to 314 (the light-receiving elements 312 and 311 in the case of FIG. 3C). Therefore, even the image of the scattered light from the defect having approximately the same size as or a smaller size than the width of the dead zones 321 to 323 can be surely detected.

### LIST OF REFERENCE SIGNS

100 . . . Magnetic disk inspection device
110 . . . Table unit
120 . . . Illumination optical system
130 . . . Scattered-light detection optical system
131 . . . First aspherical Fresnel lens
132 . . . Second aspherical Fresnel lens
133 . . . Cylindrical lens
136 . . . First photoelectric converter
310 . . . Light-receiving surface
1300 . . . Lens system

1.-10. (canceled)

11. A magnetic disk inspection device comprising:
a table unit configured to include a spindle shaft rotatable with a magnetic disk as an inspection object placed thereon, and a stage capable of moving the spindle shaft in a radial direction of the placed magnetic disk;
an illumination system configured to radiate laser onto a surface of the magnetic disk placed on the spindle shaft;
a specularly-reflected-light detection optical system configured to detect specularly reflected light among reflected light from the surface of the magnetic disk onto which the laser is radiated by the illumination system;
a scattered-light detection optical system configured to include a lens system having a plurality of lenses and a photoelectric converter having a plurality of photoelectric conversion elements arranged in an array, and to detect scattered light of the reflected light from the surface of the magnetic disk onto which the laser is radiated by the illumination system by imaging, with the lens system, an image of the scattered light from the surface of the magnetic disk into a projection region on the photoelectric conversion elements of the photoelectric converter arranged in the array, the projection region being narrower than a width of the photoelectric conversion elements in a direction perpendicular to a direction in which the photoelectric conversion elements are arranged in the array and extending in one direction; and
a signal processing unit configured to process an output from the specularly-reflected-light detection optical system by the detection of the specularly reflected light and an output from the scattered-light detection optical system by the detection of the scattered light to detect a defect on the magnetic disk.

12. The magnetic disk inspection device according to claim 11, wherein the lens system forms the image of the scattered light from the surface of the magnetic disk on the projection region which is narrower in one direction than the width of the photoelectric conversion elements in the direction perpendicular to the direction in which the photoelectric conversion elements are arranged in the array, and is longer in the other direction than a length of the array of the photoelectric conversion elements arranged.

13. The magnetic disk inspection device according to claim 11, wherein the lens system includes an objective lens, a cylindrical lens, and an imaging lens, collects the scattered light from the surface of the magnetic disk with the objective lens, shapes the collected scattered light into a light bundle extending in one direction with the cylindrical lens, and images the image of the scattered light from the surface of the magnetic disk, formed by the light bundle shaped to extend in the one direction, onto the plurality of photoelectric conversion elements of the photoelectric converter arranged in the array with the imaging lens.

14. The magnetic disk inspection device according to claim 12, wherein the lens system includes an objective lens, a cylindrical lens, and an imaging lens, collects the scattered light from the surface of the magnetic disk with the objective lens, shapes the collected scattered light into a light bundle extending in one direction with the cylindrical lens, and images the image of the scattered light from the surface of the magnetic disk, formed by the light bundle shaped to extend in the one direction, onto the plurality of photoelectric conversion elements of the photoelectric converter arranged in the array with the imaging lens.

15. The magnetic disk inspection device according to claim 13, wherein the objective lens and the imaging lens of the lens system are formed by Fresnel lenses.

16. The magnetic disk inspection device according to claim 14, wherein the objective lens and the imaging lens of the lens system are formed by Fresnel lenses.

17. The magnetic disk inspection device according to claim 11, wherein each of the plurality of photoelectric conversion elements of the photoelectric converter arranged in the array has a shape of a parallelogram, and adjacent ones of the plurality of photoelectric conversion elements are separated by an insulating member.

18. The magnetic disk inspection device according to claim 12, wherein each of the photoelectric conversion elements of the photoelectric converter arranged in the array has a shape of a parallelogram, and adjacent ones of the plurality of photoelectric conversion elements are separated by an insulating member.

19. The magnetic disk inspection device according to claim 13, wherein each of the photoelectric conversion elements of the photoelectric converter arranged in the array has a shape of a parallelogram, and adjacent ones of the plurality of photoelectric conversion elements are separated by an insulating member.

20. The magnetic disk inspection device according to claim 14, wherein each of the photoelectric conversion elements of the photoelectric converter arranged in the array has a shape of a parallelogram, and adjacent ones of the plurality of photoelectric conversion elements are separated by an insulating member.

21. A magnetic disk inspection method comprising:
rotating a spindle shaft on which a magnetic disk as an inspection object is placed, and moving the spindle shaft in a radial direction of the placed magnetic disk;
radiating laser onto a surface of the magnetic disk placed on the rotating spindle shaft;
detecting specularly reflected light among reflected light from the surface of the magnetic disk onto which the laser is radiated, with a specularly-reflected-light detection optical system;
detecting scattered light among the reflected light from the surface of the magnetic disk onto which the laser is radiated with a scattered-light detection optical system by using a lens system including a plurality of lenses and a photoelectric converter including a plurality of photoelectric conversion elements arranged in an array and by imaging, with the lens system, an image of the scattered light from the surface of the magnetic disk onto the photoelectric conversion elements of the photoelectric converter arranged in the array and detecting the image of the scattered light, the image of the scattered light being shaped to be narrower than a width of the photoelectric conversion elements in a direction perpendicular to a direction in which the photoelectric conversion elements are arranged in the array and to extend in one direction; and
processing an output from the specularly-reflected-light detection optical system detecting the specularly reflected light and an output from the scattered-light detection optical system detecting the scattered light to detect a defect on the magnetic disk.

22. The magnetic disk inspection method according to claim 21, wherein the lens system images the image of the scattered light, extending in the one direction, from the surface of the magnetic disk onto the plurality of photoelectric conversion elements of the photoelectric converter arranged in the array, the image is shaped to be narrower in one direction than the width of the photoelectric conversion elements in the direction perpendicular to the direction in which the plurality of photoelectric conversion elements are arranged in the array, and is shaped to be longer in the other direction than a length of the array of the photoelectric conversion elements arranged.

23. The magnetic disk inspection method according to claim 21, wherein the lens system includes an objective lens, a cylindrical lens, and an imaging lens, collects the scattered light from the surface of the magnetic disk by the objective lens, shapes the collected scattered light into a light bundle extending in one direction by the cylindrical lens, and images the image of the scattered light from the surface of the magnetic disk, formed by the light bundle shaped to extend in the one direction, by the imaging lens onto the plurality of photoelectric conversion elements of the photoelectric converter arranged in the array.

24. The magnetic disk inspection method according to claim 22, wherein the lens system includes an objective lens, a cylindrical lens, and an imaging lens, collects the scattered light from the surface of the magnetic disk by the objective lens, shapes the collected scattered light into a light bundle extending in one direction by the cylindrical lens, and images the image of the scattered light from the surface of the magnetic disk, formed by the light bundle shaped to extend in the one direction, by the imaging lens onto the plurality of photoelectric conversion elements of the photoelectric converter arranged in the array.

25. The magnetic disk inspection method according to claim 23, wherein collecting the scattered light from the surface of the magnetic disk with the objective lens of the lens system and imaging the image of the scattered light from the surface of the magnetic disk, formed by the light bundle shaped to extend in the one direction, onto the plurality of photoelectric conversion elements of the photoelectric converter arranged in the array are performed by using Fresnel lenses.

26. The magnetic disk inspection method according to claim 24, wherein collecting the scattered light from the surface of the magnetic disk with the objective lens of the lens system and imaging the image of the scattered light from the surface of the magnetic disk, formed by the light bundle shaped to extend in the one direction, onto the plurality of photoelectric conversion elements of the photoelectric converter arranged in the array are performed by using Fresnel lenses.

27. The magnetic disk inspection method according to claim 21, wherein the image of the scattered light from the surface of the magnetic disk is detected by using the photoelectric converter including the plurality of photoelectric conversion elements that have a parallelogram shape and are arranged in the array, adjacent ones of the photoelectric conversion elements are separated by an insulating member.

28. The magnetic disk inspection method according to claim 22, wherein the image of the scattered light from the surface of the magnetic disk is detected by using the photoelectric converter including the plurality of photoelectric conversion elements that have a parallelogram shape and are arranged in the array, adjacent ones of the photoelectric conversion elements are separated by an insulating member.

29. The magnetic disk inspection method according to claim 23, wherein the image of the scattered light from the surface of the magnetic disk is detected by using the photoelectric converter including the plurality of photoelectric conversion elements that have a parallelogram shape and are arranged in the array, adjacent ones of the photoelectric conversion elements are separated by an insulating member.

30. The magnetic disk inspection method according to claim 24, wherein the image of the scattered light from the surface of the magnetic disk is detected by using the photoelectric converter including the plurality of photoelectric conversion elements that have a parallelogram shape and are arranged in the array, adjacent ones of the photoelectric conversion elements are separated by an insulating member.
